(19) United States
(12) Patent Application Publication
(10) Pub. No.: US 2007/0040966 A1
(43) Pub. Date: Feb. 22, 2007

(54) Optical reflective member

(75) Inventors: Miyuki Teramoto, Osakasayama-shi (JP); Setsuo Tokuhiro, Tokorozawa-shi (JP); Takuji Hatano, Suita-shi (JP)

Correspondence Address: SIDLEY AUSTIN LLP, 717 NORTH HARWOOD, SUITE 3400, DALLAS, TX, 75201, US

(73) Assignee: KONICA MINOLTA OPTO, INC.

(21) Appl. No.: 11/505,103

(22) Filed: Aug. 15, 2006

(30) Foreign Application Priority Data
Aug. 16, 2005 (JP) 2005-235775

(51) Int. Cl. G02F 1/1335

(52) U.S. Cl. 349/113

(57) ABSTRACT

On the surface of a plastic base, there are formed, from the base side, an adhesion layer, a reflective layer formed mainly of Ag, and a protective layer formed of a light-transmitting dielectric layer. The adhesion layer is formed of a layer of a mixture of aluminum oxide and lanthanum oxide, and is given a thickness in the range from 10 nm to 120 nm. To further enhance the adhesion between the base and the Ag layer, and to surely prevent entry of moisture or the like from the base into the Ag layer, the mix proportion of lanthanum oxide in the adhesion layer is preferably kept in the range from 60% to 80% by weight.

This application is based on Japanese Patent Application No. 2005-235775 filed on Aug. 16, 2005, the contents of which are hereby incorporated by reference.

### BACKGROUND OF THE INVENTION

1. Field of the Invention

The present invention relates to an optical reflective member having a reflective layer formed mainly of Ag, and more particularly to an optical reflective member for use in an optical apparatuses such as cameras and projectors.

2. Description of Related Art

In optical apparatuses such as cameras and projectors, it is common to provide an optical reflective member on the optical path. In an optical reflective member for use in such an optical apparatus, its reflective surface is required to have a high reflectivity to produce a bright image. A well-known material for a reflective surface having a high reflectivity is Ag. A reflective surface formed of Ag offers a reflectivity as high as 98% over the entire wavelength range of visible light, and thus Ag is extremely suitable as a material for a reflective mirror used in an optical apparatus.

Disadvantageously, however, Ag is liable to deteriorate in contact with moisture and sulfur- and salt-containing substances in air, and this tends to cause the reflectivity of an optical apparatus to lower significantly with time. On the other hand, in recent years, plastic members have been increasingly replacing glass members in optical apparatuses. When a plastic member is used as a base on which to form a reflective layer, inconveniently, the just mentioned disadvantage becomes more noticeable. In addition, the adhesion between a plastic member and an Ag layer is not quite satisfactory.

To overcome these disadvantages, there has been proposed a technique that attempts to enhance adhesion with a plastic base and resistance to corrosion by forming on the base a multilayer film consisting of films of Al₂O₃, Ag, Al₂O₃, and TiO₂ (JP-A-2003-4919).

In reality, however, an experiment that the inventors of the present invention conducted with the conventionally proposed technique mentioned above revealed that, in a high-temperature/high-humidity test, the Ag layer deteriorated violently and that, in a salt water spray test, which will be described later, the Ag layer exfoliated (refer to Comparative Example 1 presented herein).

On the other hand, as a material for the base of an optical member, cycloolefin resin has recently been receiving attention for its low hygroscopicity and its excellent heat resistance and injection moldability. In a reflective mirror used in an image projection apparatus such as a projector, a variation in its surface shape causes a distortion in the image produced; thus, there, a member whose surface shape is unlikely to vary is particularly desired. Here, luckily, cycloolefin resin has the property that its surface shape is less likely to vary than that of other plastic materials. Disadvantageously, however, when cycloolefin resin is used as the base of an optical reflective member, the reflective film tends to develop cracks.

### SUMMARY OF THE INVENTION

In view of the conventionally encountered disadvantages mentioned above, it is an object of the present invention to provide an optical reflective member that, despite using cycloolefin resin as the material of its base, does not develop cracks in its reflective film and that in addition excels in adhesion, corrosion resistance, and durability.

To achieve the above object, according to one aspect of the present invention, an optical reflective member has formed on the surface of a plastic base, from the base side: an adhesion layer; a reflective layer formed mainly of Ag (also referred to as the “Ag Layer”); and a protective layer formed of a light-transmitting dielectric layer. Here, the plastic base is formed of cycloolefin resin, and the adhesion layer is formed of a layer of a mixture of aluminum oxide and lanthanum oxide and has a thickness in the range from 10 nm to 120 nm. This leads to lower hygroscopicity, effectively preventing entry of moisture from the base into the Ag layer. In addition, excellent injection moldability is obtained, permitting processing into various shapes. Furthermore, excellent heat resistance is obtained, preventing heat-induced deformation. Moreover, even when cycloolefin resin is used as the material of the base, the Ag layer does not develop cracks, but rather offers enhanced adhesion with the base, and also offers enhanced corrosion resistance and durability. In the present specification, a high-refractive-index material denotes one having a refractive index of 1.9 or more, and a low-refractive-index material denotes one having a refractive index less than 1.7.

According to another aspect of the present invention, a projection apparatus comprises: a display panel having a display panel surface on which a two-dimensional image is displayed; and a projection optical system for projecting, while enlarging, the two-dimensional image formed on the display panel surface. This projection optical system is provided with an optical reflective member, which has formed on the surface of a plastic base, from the base side: an adhesion layer; a reflective layer formed mainly of Ag; and a protective layer formed of a light-transmitting dielectric layer. Here, the plastic base is formed of cycloolefin resin, and the adhesion layer is formed of a layer of a mixture of aluminum oxide and lanthanum oxide and has a thickness in the range from 10 nm to 120 nm. This design ensures projection of sharp images for a long period.

According to still another aspect of the present invention, an image-sensing apparatus is provided with: an optical reflective member. This optical reflective member has formed on the surface of a plastic base, from the base side: an adhesion layer; a reflective layer formed mainly of Ag; and a protective layer formed of a light-transmitting dielectric layer. Here, the plastic base is formed of cycloolefin resin, and the adhesion layer is formed of a layer of a mixture of aluminum oxide and lanthanum oxide and has a thickness in the range from 10 nm to 120 nm. This design ensures sensing of sharp images for a long period.

### BRIEF DESCRIPTION OF THE DRAWINGS

FIG. 1 is a diagram schematically showing the layer structure of the reflective mirror of Practical Example 1 according to the invention;

FIG. 2 is a diagram schematically showing the layer structure of the reflective mirror of Practical Example 2 according to the invention;

FIG. 3 is a diagram schematically showing the layer structure of the reflective mirror of Practical Example 3 according to the invention;

FIG. 4 is a diagram schematically showing the layer structure of the reflective mirror of Practical Example 4 according to the invention;

FIG. 5 is a diagram schematically showing the layer structure of the reflective mirror of Practical Example 5 according to the invention;

FIG. 6 is a diagram schematically showing the layer structure of the reflective mirror of Practical Example 6 according to the invention;

FIG. 7 is a diagram schematically showing the layer structure of the reflective mirror of Practical Example 7 according to the invention;

FIG. 8 is a diagram schematically showing the layer structure of the reflective mirror of Practical Example 8 according to the invention;

FIG. 9 is a diagram schematically showing the layer structure of the reflective mirror of Practical Example 9 according to the invention;

FIG. 10 is a diagram schematically showing the layer structure of the reflective mirror of Practical Example 10 according to the invention;

FIG. 11 is a diagram schematically showing the layer structure of the reflective mirror of Practical Example 11 according to the invention;

FIG. 12 is a diagram schematically showing the layer structure of the reflective mirror of Practical Example 12 according to the invention;

FIG. 13 is a diagram schematically showing the layer structure of the reflective mirror of Practical Example 13 according to the invention;

FIG. 14 is a diagram schematically showing the layer structure of the reflective mirror of Comparative Example 1;

FIG. 15 is a diagram schematically showing the layer structure of the reflective mirror of Comparative Example 2;

FIG. 16 is a diagram schematically showing the layer structure of the reflective mirror of Comparative Example 3;

FIG. 17 is a diagram schematically showing the layer structure of the reflective mirror of Comparative Example 4;

FIG. 18 is a diagram schematically showing the layer structure of the reflective mirror of Comparative Example 5;

FIG. 19 is a diagram schematically showing the layer structure of the reflective mirror of Comparative Example 6;

FIG. 20 is a diagram schematically showing the layer structure of the reflective mirror of Comparative Example 7;

FIG. 21 is a diagram schematically showing the layer structure of the reflective mirror of Comparative Example 8;

FIG. 22 is a diagram schematically showing the layer structure of the reflective mirror of Comparative Example 9;

FIG. 23 is a diagram schematically showing the construction of a single-lens-reflex camera employing an optical reflective member according to the invention; and

FIG. 24 is a diagram schematically showing the construction of a projector employing an optical reflective member according to the invention.

### DETAILED DESCRIPTION OF PREFERRED EMBODIMENTS

One of the distinctive features of optical reflective members according to the present invention is that they use plastic bases formed of cycloolefin resin. Since cycloolefin resin offers excellent injection moldabilty, its use leads to far better moldability and far lighter weights than can be achieved with conventionally widely used glass bases. Moreover, since cycloolefin resin is little hygroscopic, it helps prevent entry of moisture from the base into an Ag layer.

There is no particular limitation to the kind of cycloolefin resin used in the present invention; commercially available examples thereof include: “ZEONEX (registered trademark)” and “ZEONOR (registered trademark)” manufactured by Zeon Corporation, Japan; and “APEL (registered trademark)” manufactured by Mitsui Chemicals Inc., Japan”.

Inconveniently, however, when cycloolefin resin is used as the material of the base, the Ag layer tends to develop cracks. Through an intensive study in search of a solution to this inconvenience, the inventors of the present invention have found out that the aim is achieved by providing an adhesion layer between the Ag layer and the plastic base and using as the adhesion layer a layer of a mixture of aluminum oxide and lanthanum oxide. This mixture layer exhibits superb adhesion with cycloolefin resin, and offers excellent barrier resistance to prevent entry of moisture and sulfur-containing substances. This is another of the distinctive features of the present invention.

It is important that the thickness of the layer of a mixture of aluminum oxide and lanthanum oxide be in the range from 10 nm to 120 nm. If the thickness of the mixture layer is less than 10 nm, it does not sufficiently prevent entry of moisture etc. from the base into the Ag layer. If the thickness of the mixture layer is more than 120 nm, the Ag layer develops cracks. A further preferable range of the thickness of the mixture layer is from 30 nm to 60 nm.

It is preferable that the proportion of lanthanum oxide in the mixture layer be in the range from 60% to 80% by weight. If the proportion of lanthanum oxide is less than 60% by weight, insufficient durability may result through reliability tests including a salt water spray test. If the proportion of lanthanum oxide is more than 80% by weight, the film may develop cracks.

It is advisable that the reflective layer formed mainly of Ag be given a thickness of 100 nm or more. With a thickness less than 100 nm, the reflective layer may fail to offer a sufficient refractive index in the wavelength range of visible light. With productivity and other factors taken into consideration, it is preferable that the thickness of the reflective layer be in the range from 120 nm to 170 nm. There is no particular limitation to the process by which to form the Ag layer as the reflective layer; it may be formed by any conventionally know process such as vacuum deposition or sputtering. It is, however, preferable to use a process that ionizes Ag to form the Ag layer. Ionizing Ag helps make the surface of the Ag layer smooth and fine-grained, leading to enhanced durability.

In an optical reflective member according to the present invention, outside the reflective layer, a protective layer is formed that is formed of a light-transmitting dielectric layer. This prevents entry of moisture, sulfur-containing substances, etc. into the Ag layer. There is no particular limitation to the layer structure and materials of the protective layer; from the viewpoint of preventing entry of moisture, sulfur-containing substances, etc. into the Ag layer, however, it is preferable that the protective layer have part thereof formed of low-refractive-index layers and high-refractive-index layers laid alternately on one another. The outermost layer of the protective layer may be a high-refractive-index layer or a low-refractive-index layer.

It is preferable that the high-refractive-index layers be formed of at least one of the following materials: a mixture of titanium oxide and dysprosium oxide, a mixture of titanium oxide and lanthanum oxide, and a mixture of titanium oxide and tantalum oxide. The high-refractive-index layers may be formed of titanium oxide or tantalum oxide alone; when they are formed of one of these materials under almost unheated conditions, however, low fill density results, leading to insufficient durability. Thus, it is advisable that the high-refractive-index layers be formed of one or more of the mixtures mentioned above.

It is preferable that the low-refractive-index layers be formed of a material that offers barrier resistance against moisture and sulfur, and, from the viewpoint of securing satisfactory optical reflection performance, it is preferable that the material differ greatly in refractive index from the high-refractive-index layers on which it is laid. When compared in barrier resistance, different low-refractive-index materials rank as follows: silicon oxide<(mixture of silicon oxide and aluminum oxide)<aluminum oxide<(mixture of aluminum oxide and lanthanum oxide). However, since a mixture of aluminum oxide and lanthanum oxide has a high refractive index, namely 1.73, when this mixture is used as the material of the low-refractive-index layers, it may be difficult to obtain a high refractive index over the entire wavelength range of visible light. Accordingly, it is preferable that the low-refractive-index layers be formed of at least one of the following materials: silicon oxide, aluminum oxide, and a mixture of silicon oxide and aluminum oxide.

An advisable combination of the materials of the high- and low-refractive-index layers is: layers of a mixture of titanium oxide and tantalum oxide as the high-refractive-index layers, and layers of aluminum oxide or layers of a mixture of aluminum oxide and silicon oxide as the low-refractive-index layers. This combination offers the best barrier resistance and durability. The high- and low-refractive-index layers may be alternated once, or twice or more times. From the viewpoint of productivity, however, it is preferable that the number of alternations be as small as possible. Moreover, it is preferable that the lowermost layer of the protective layer, that is, the dielectric layer lying in contact with the Ag layer, be a layer of aluminum oxide. Using a layer of aluminum oxide as the dielectric layer lying in contact with the Ag layer helps increase the hardness of the protective layer as a whole. On the other hand, from the viewpoint of enhancing mar resistance, the topmost layer of the protective layer may be formed of a low-refractive-index layer. It is preferable that the low-refractive-index layer formed as the topmost layer be formed of silicon oxide or a mixture of silicon oxide and aluminum oxide. Incidentally, when compared in mar resistance, different low-refractive-index materials rank as follows: silicon oxide, (mixture of silicon oxide and aluminum oxide)>(mixture of titanium oxide and lanthanum oxide), (mixture of titanium oxide and tantalum oxide)>aluminum oxide, titanium oxide.

There is no particular limitation to the process by which to form the adhesion layer and the protective layer; they may be formed by any conventionally know process such as vacuum deposition, IAD (ion-assisted deposition), IP (ion-plating), CVD (chemical vapor deposition), or sputtering. Among these processes, IDA is recommendable as one by which to form the adhesion layer and the protective layer. IDA helps make the layers fine-grained, leading to enhanced durability.

Optical reflective members according to the present invention can be used, for example, in pentagonal roof mirrors for use in single-lens-reflex cameras and in curved-surface reflective mirrors for use in projectors.

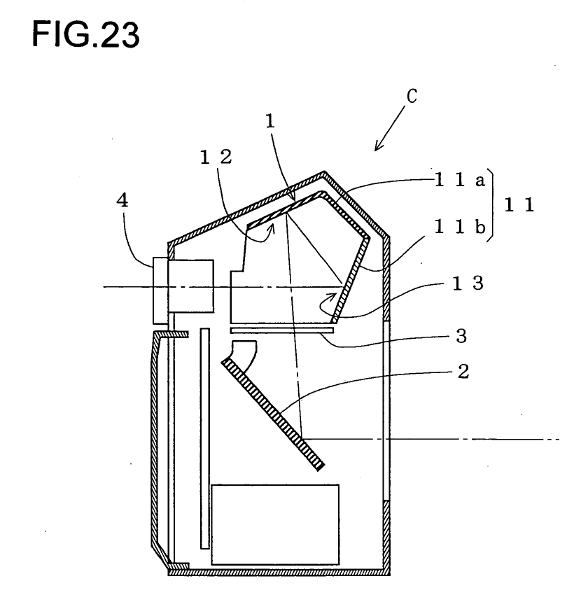

FIG. 23 is a diagram schematically showing the construction of a single-lens-reflex camera that employs, in a pentagonal roof mirror, an optical reflective member according to the present invention. In the single-lens-reflex camera C shown in FIG. 23, a focusing screen 3 that extends horizontally is provided above a quick return mirror 2, and a pentagonal roof mirror 1 is provided so that the subject image focused on the focusing screen 3 can be observed as a both vertically and horizontally normal image through a viewfinder eyepiece 4. Conventionally, a pentagonal prism is used to permit the subject image to be observed as a both vertically and horizontally normal image. Since pentagonal prisms are heavy, however, in recent years, pentagonal roof mirrors have been increasingly replacing them to meet the demands for increasingly light cameras.

The pentagonal roof mirror 1 has a shell-shaped base 11 formed of cycloolefin resin. Of the base 11, a front-wall part on which a flat mirror 13 is formed is separated from the other part to form one member 11b, and the other part is molded as another member 11a. These two members 11 and 11b are then bonded together to form a single unit. To conform to the structure of a conventional pentagonal prism mirror, the pentagonal roof mirror 1 has a Dach mirror 12 that reflects the light incident from the focusing screen 3 and a flat mirror 13 that further reflects the light reflected from the Dach mirror 12 to direct it to the viewfinder eyepiece 4. The Dach mirror 12 is formed on the mutually adjacent, mutually perpendicular, and inward facing flat surfaces of the member 11a. On the other hand, the flat mirror 13 is formed on the surface of the member 11b. When the members 11a and 11b are bonded together, the Dach mirror 12 and the flat mirror 13 are both located inside the shell-shaped base 11, thus permitting the subject image focused on the focusing screen 3 to be directed, as a both vertically and horizontally normal image, through the pentagonal roof mirror 1 to the viewfinder eyepiece 4. A layer structure defined in the present invention offers excellent durability and environment resistance. Thus, an optical reflective member according to the present invention can suitably be used in a pentagonal roof mirror as described above.

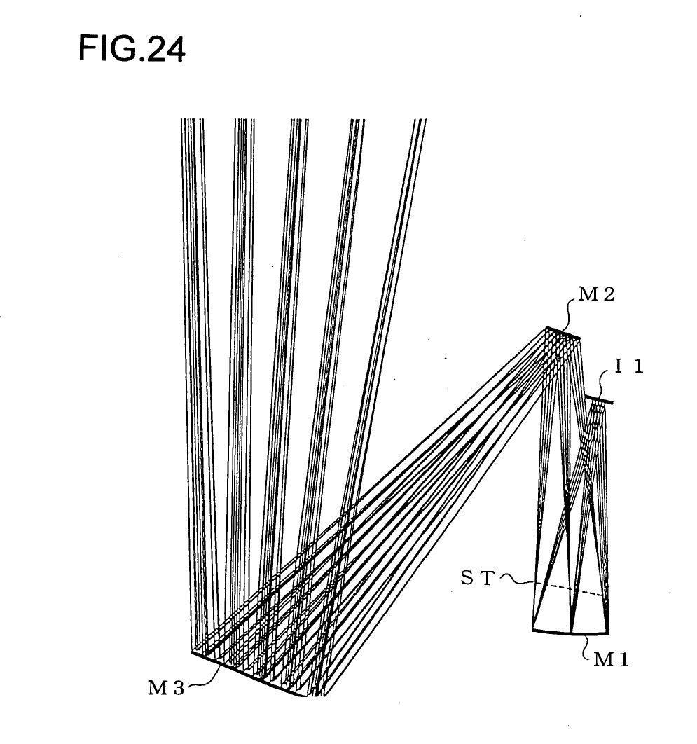

An optical reflective member according to the present invention can also be used as a curved-surface reflective mirror for use in a projector. FIG. 24 is a diagram schematically showing the construction of the rear projection optical system used in a rear-projection image projection apparatus (rear projector) that employs, as curved-surface reflective mirrors, optical reflective members according to the present invention.

The rear projection optical system shown in FIG. 24 is provided with a projection optical system that, assuming that the image display surface of a display panel serves as a panel display surface on the reduction side, projects, while enlarging, a two-dimensional image formed on the panel display surface (I1) onto a screen surface (unillustrated). Used as the display panel is, for example, a display device such as a reflective liquid crystal panel, a transmissive liquid crystal panel, or a DMD (digital micromirror device). The panel display surface (I1) is illuminated with light emitted from a lamp (unillustrated) and passed through an illumination optical system (unillustrated). From the panel display surface (I1) thus illuminated, projection light emanates, which is then directed by the projection optical system etc. to the screen surface (unillustrated). A color image can be projected by adopting a three-panel construction that uses three display panels and integrates colors with cross dichroic prisms or the like, or a single-panel construction that displays an image on a time-division basis, or a single-panel construction that uses a microlens array provided on the display panel.

In the projection optical system shown in FIG. 24, there are provided, from the panel display surface (I1) side, a first mirror M1, a second mirror M2, and a third mirror M3. The aperture position (ST) in the figure corresponds to the virtual aperture plane. The first to third mirrors M1 to M3 are all curved-surface reflective mirrors all having free-form curved surfaces. The projection light emanating from the panel display surface (I1) is reflected on one after another of the three curved-surface reflective mirrors that build the projection optical system, and then has its optical path turned twice by unillustrated flat reflective mirrors to reach the unillustrated screen surface.

In this embodiment, the projector has a light source, which emits heat, and the individual optical components not only transmit and reflect light but also absorb certain amounts of heat; thus, their temperatures rise after the lamp is turned on. In addition, the ambient temperature is not constant. Thus, the rear projection optical system is required to offer satisfactory performance stably in the face of temperature variation. Moreover, it is generally known that the error sensitivity of reflective optical components such as reflective mirrors is twice or more as high as that of ordinary transmissive optical components. Thus, as the material for the bases of curved-surface reflective mirrors, glass has conventionally been widely used because its performance varies comparatively little with temperature variation. Optical reflective members according to the present invention have their bases molded of cycloolefin resin, which offers excellent heat resistance, and can thus be used as such curved-surface reflective mirrors. As a result of plastic replacing glass as the material of the bases, it is possible to make the apparatus lightweight and inexpensive, and also to obtain excellent durability and environmental resistance.

### EXAMPLES

Hereinafter, the present invention will be presented in more detail by way of practical examples. It should be understood that the practical examples presented below are not meant to limit the present invention in any way, and that many modifications and variations made within the spirit of what is described herein and claimed in the appended claims are encompassed in the technical scope of the present invention.

### Practical Examples 1 to 13 and Comparative Examples 1 to 9

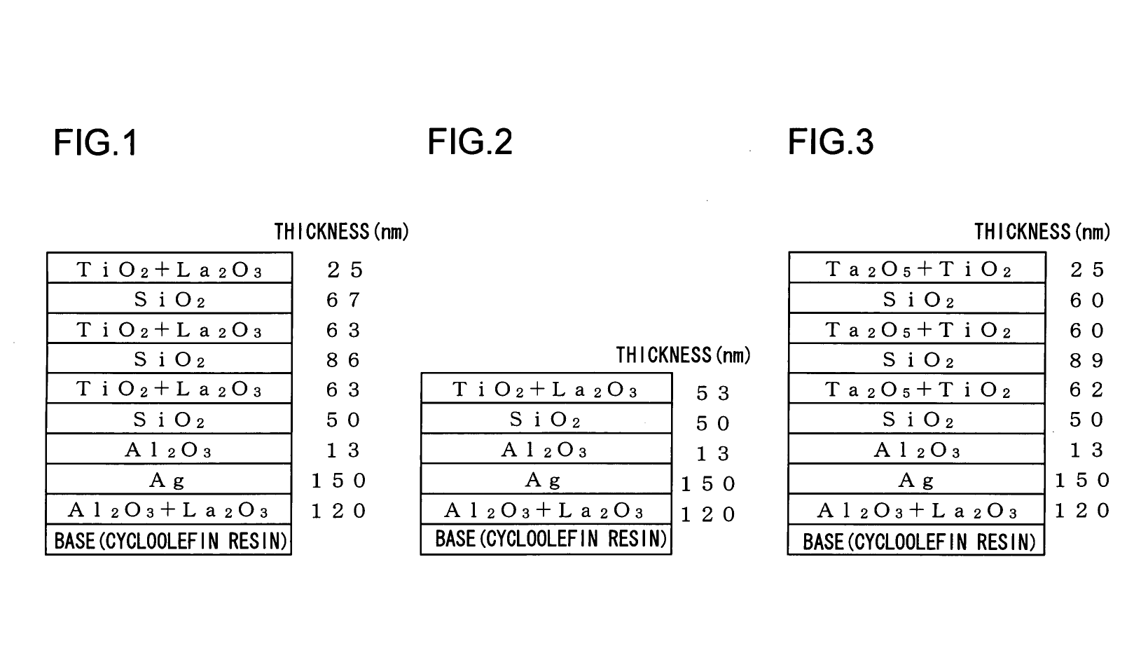

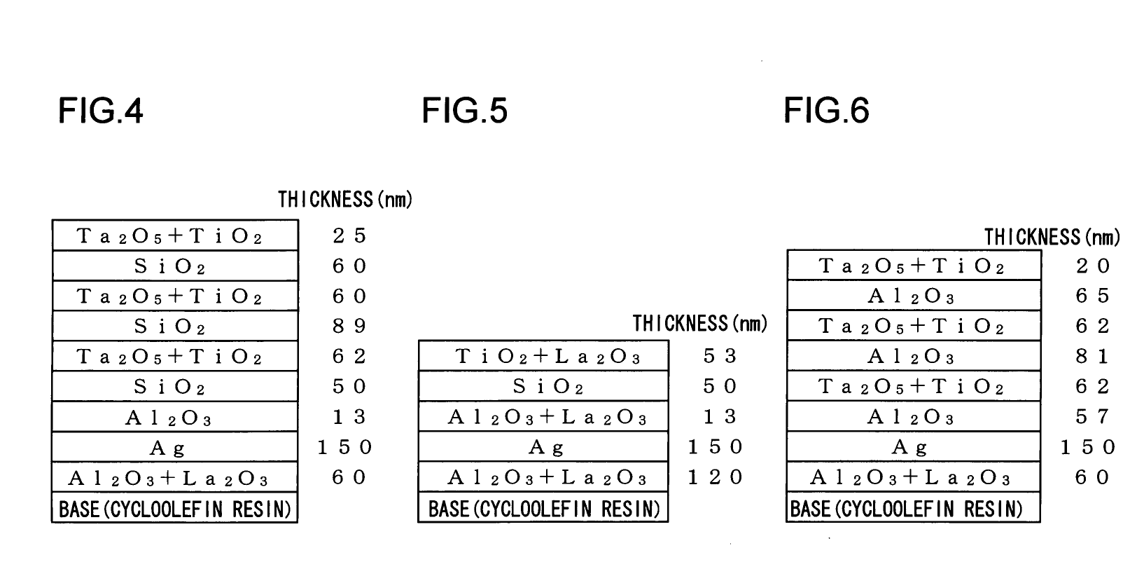

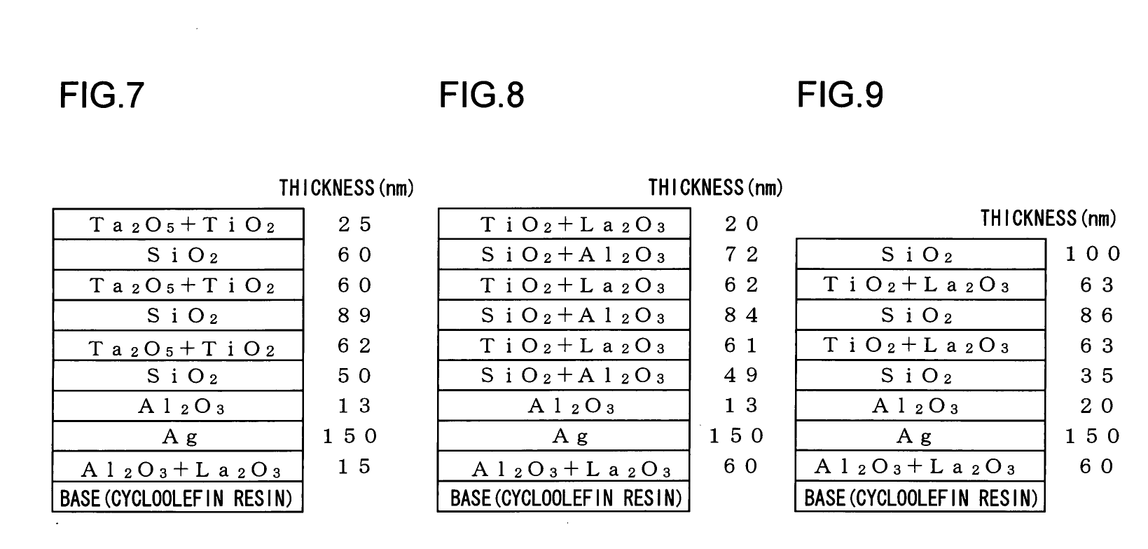

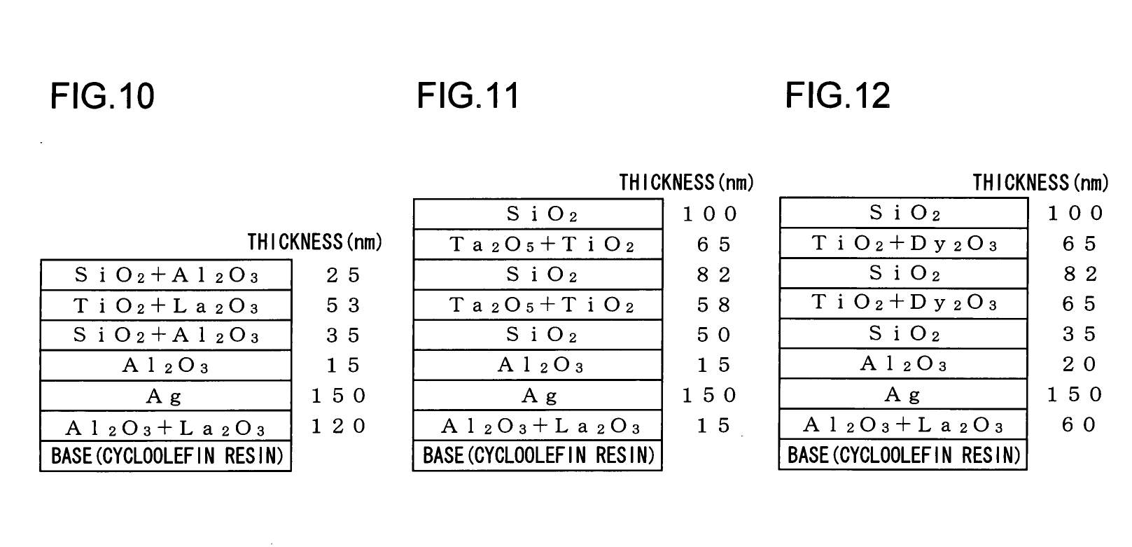

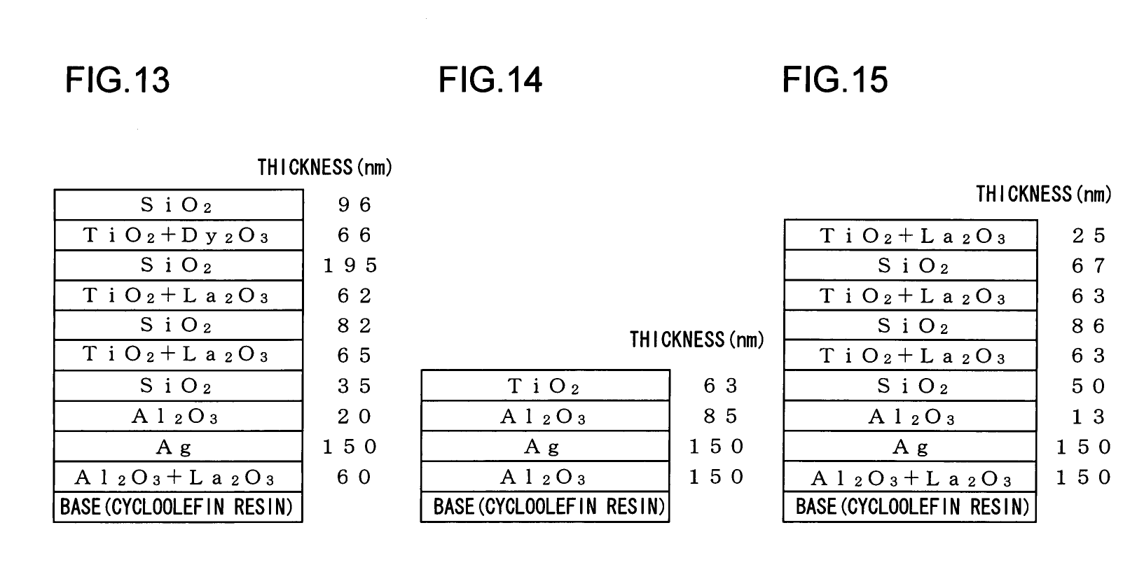

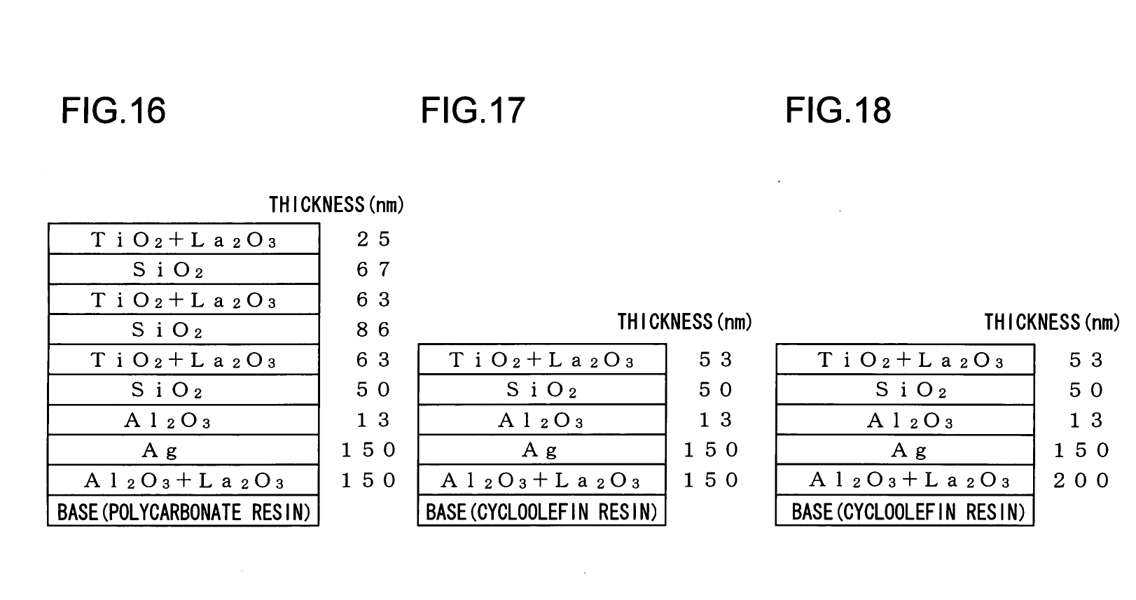

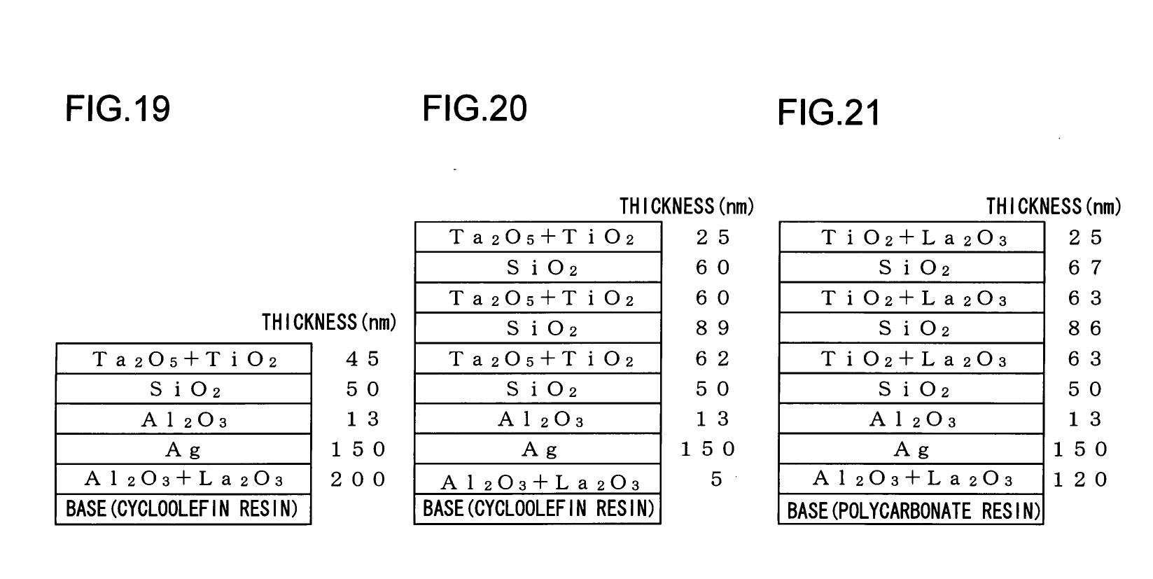

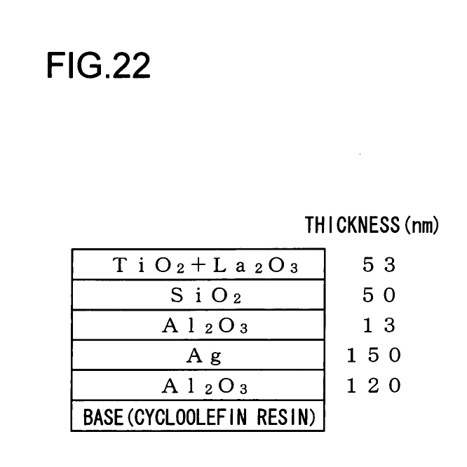

As shown in each of FIGS. 1 to 22, on top of a base, different layers are formed on one another by vacuum deposition. Here, the layer laid between the base and an Ag layer is the adhesion layer, and all the layers laid outside the Ag layer together form the protective layer. With each of the reflective mirrors thus produced, the evaluation tests described below were conducted. The results are shown in Table 1. It should be noted that Comparative Example 1 is the reflective mirror according to JP-A-2003-4919 mentioned earlier, as the inventors of the present invention experimented with it. All the layers other than the Ag layer were formed by electron beam evaporation while oxygen gas was being introduced. The Ag layer was formed by resistance heating deposition without introduction of oxygen gas. During the formation of all the layers, the base was not heated.

High-Temperature/High-Humidity Test

The reflective mirrors produced were left for 168 hours (7 days) under the following environmental conditions: temperature, 60° C.; humidity, 90% RH. Then, their appearance was inspected with the eye, and their reflectivity was measured.

Salt Water Spray Test

A test conforming to “MIL-M-13508C” was conducted. Specifically, the reflective mirrors produced were sprayed with a 5% NaCl water solution for 24 hours under the following environmental condition: temperature, 35° C. Then, as in the test described just above, their appearance was inspected with the eye, and their reflectivity was measured.

Mar-Resistance Test

With each of the reflective mirrors produced, a lens cleaning wiper “Dasper K-3” manufactured by Ozu Corporation, Japan, was dampened with ethanol, and was run across the layer surface to-and-fro ten times under a load of 50 g. Then, the layer surface was inspected for scratches under a microscope and with the eye.

The defects observed in the evaluation of the appearance were classified into the following types: “cracks” when fine cracks were observed over the entire layer surface; “exfoliation” when the formed layers exfoliated (comes slightly apart) from the base and disappeared when touched; “whitening” when Ag flocculated and made the layer surface appear rough (diffusive) and hence white; and “fogging” when a light degree of whitening was observed and the layer surface, while it did reflect light, appeared whitish.

The materials that were used in the practical and comparative examples and their refractive indices are as follows:
A mixture of aluminum oxide and lanthanum oxide, manufactured under the product name “M3” by Merck Ltd., Japan, with a refractive index of 1.73;
Aluminum oxide, with a refractive index of 1.62;
A mixture of silicon oxide and aluminum oxide, manufactured under the product name “L5” by Merck Ltd., Japan, with a refractive index of 1.48;
Silicon oxide, with a refractive index of 1.46;
A mixture of titanium oxide and lanthanum oxide, manufactured under the product name “H4” by Merck Ltd., Japan, with a refractive index of 1.95;
A mixture of titanium oxide and tantalum oxide, manufactured under the product name “OA-600” by Canon Optron Inc., Japan, with a refractive index of 1.97; and
A mixture of titanium oxide and dysprosium oxide, manufactured under the product name “H6” by Merck Ltd., Japan, with a refractive index of 2.0.

The mix proportions of the mixture materials that were used in the practical and comparative examples are as follows:
The mixture of aluminum oxide and lanthanum oxide, containing 72.7% by weight of lanthanum oxide;
The mixture of silicon oxide and aluminum oxide, containing 97.0% by weight of silicon oxide;
The mixture of titanium oxide and lanthanum oxide, containing 67.1% by weight of lanthanum oxide;
The mixture of titanium oxide and tantalum oxide, containing 95.0% by weight of tantalum oxide; and
The mixture of titanium oxide and dysprosium oxide, containing 70% by weight of dysprosium oxide.

The symbols used in Table 1 are as follows:
For appearance evaluation,
   “◯” represents “no defect observed”;
   “Δ” represents “a defect observed only when closely inspected”; and
   “X” represents “a defect readily observed”.
For reflectivity evaluation,
   “◯” represents “no lowering in reflectivity observed”;
   “Δ” represents “reflectivity lowered by less than 2%”; and
   “X” represents “reflectivity lowered by 2% or more”.
For mar-resistance evaluation,
   “⊚” represents “no change whatsoever observed”;
   “◯” represents “a scratch observed under a microscope”;
   “Δ” represents “a scratch observed with the eye”; and
   “X” represents “layers exfoliated”.

As will be understood from Table 1, the optical reflective members according to the present invention, namely the reflective mirrors of Practical Examples 1 to 13, exhibited no change in appearance and no lowering in reflectivity throughout the high-temperature/high-humidity test and the salt water spray test. In the mar-resistance test also, they developed no practically intolerable exfoliation in the layers. An observation under a microscope of the protective layers of Practical Examples 12 and 13, where the high-refractive-index layers of the protective layer were formed of (TiO₂+Dy₂O₃), revealed that they had less pin holes than the protective layers in the reflective mirrors of Practical Examples 1 to 11, where the high-refractive-index layers of the protective layer were formed of (TiO₂+La₂O₃). Thus, Practical Examples 12 and 13 are expected to offer higher durability even in a test conducted under heavier load.

By contrast, in the reflective mirror of Comparative Example 1, where the adhesion layer was formed of Al₂O₃ and the adhesion layer thickness was greater than the range defined in the present invention, after the high-temperature/high-humidity test, “whitening” was observed, and the reflectivity lowered by 2% or more. Moreover, after the salt water spray test, “exfoliation” was observed, and the reflectivity lowered by 2% or more. In the reflective mirror of Comparative Example 9, where the adhesion layer thickness was within the range defined in the present invention but the adhesion layer was formed of Al₂O₃, after the high-temperature/high-humidity test, “fogging” was observed, and the reflectivity lowered by less than 2%. Moreover, after the salt water spray test, as in the reflective mirror of Comparative Example 1, “exfoliation” was observed, and the reflectivity lowered by 2% or more.

In the reflective mirror of Comparative Example 3, where the base was formed of polycarbonate resin and the adhesion layer thickness was greater than the range defined in the present invention, after the high-temperature/high-humidity test, no defect was observed, but, after the salt water spray test, “whitening” was observed, and the reflectivity lowered by 2% or more. In the reflective mirror of Comparative Example 8, where the adhesion layer thickness was within the range defined in the present invention but the base was formed of polycarbonate resin, after the high-temperature/high-humidity test, no defect was observed, but, after the salt water spray test, but, after the salt water spray test, “fogging” was observed, and the reflectivity lowered by less than 2%.

In the reflective mirrors of Comparative Examples 2 and 4 to 6, where the adhesion layer thickness was greater than the range defined in the present invention, both after the high-temperature/high-humidity test and after the salt water spray test, “cracks” developed, and the reflectivity lowered by 2% or more. In the reflective mirror of Comparative Example 7, where the adhesion layer thickness is smaller than the range defined in the present invention, both after the high-temperature/high-humidity test and after the salt water spray test, “exfoliation” was observed, and the reflectivity lowered by 2% or more.

TABLE 1

| | High Temperature/Humidity | | | Salt Water Spray Test | | | |
|---|---|---|---|---|---|---|---|
| | Test (60° C., 90%, 168 H) | | | (35° C., 24 H) | | | Mar |
| | Appearance | | Reflectivity | Appearance | | Reflectivity | Resistance |
| Practical Example 1 | ◯ | Good | ◯ | ◯ | Good | ◯ | ◯ |
| Practical Example 2 | ◯ | Good | ◯ | ◯ | Good | ◯ | Δ |
| Practical Example 3 | ◯ | Good | ◯ | ◯ | Good | ◯ | ◯ |
| Practical Example 4 | ◯ | Good | ◯ | ◯ | Good | ◯ | ◯ |
| Practical Example 5 | ◯ | Good | ◯ | ◯ | Good | ◯ | Δ |
| Practical Example 6 | ◯ | Good | ◯ | ◯ | Good | ◯ | ◯ |
| Practical Example 7 | ◯ | Good | ◯ | ◯ | Good | ◯ | ◯ |
| Practical Example 8 | ◯ | Good | ◯ | ◯ | Good | ◯ | ◯ |
| Practical Example 9 | ◯ | Good | ◯ | ◯ | Good | ◯ | ⊚ |
| Practical Example 10 | ◯ | Good | ◯ | ◯ | Good | ◯ | ⊚ |
| Practical Example 11 | ◯ | Good | ◯ | ◯ | Good | ◯ | ⊚ |
| Practical Example 12 | ◯ | Good | ◯ | ◯ | Good | ◯ | ⊚ |
| Practical Example 13 | ◯ | Good | ◯ | ◯ | Good | ◯ | ⊚ |
| Comparative Example 1 | X | Whitening | X | X | Exfoliation | X | X |
| Comparative Example 2 | X | Cracks | X | X | Cracks | X | ◯ |
| Comparative Example 3 | ◯ | Good | X | X | Whitening | X | ◯ |
| Comparative Example 4 | X | Cracks | X | X | Cracks | X | Δ |
| Comparative Example 5 | X | Cracks | X | X | Cracks | X | Δ |
| Comparative Example 6 | X | Cracks | X | X | Cracks | X | Δ |
| Comparative Example 7 | X | Exfoliation | X | X | Exfoliation | X | ◯ |
| Comparative Example 8 | ◯ | Good | ◯ | Δ | Fogging | Δ | ◯ |
| Comparative Example 9 | Δ | Fogging | Δ | X | Exfoliation | X | Δ |

What is claimed is:

1. An optical reflective member having formed on a surface of a plastic base, from a base side:
an adhesion layer;
a reflective layer formed mainly of Ag; and
a protective layer formed of a light-transmitting dielectric layer,
wherein
the plastic base is formed of cycloolefin resin, and
the adhesion layer is formed of a layer of a mixture of aluminum oxide and lanthanum oxide and has a thickness in a range from 10 nm to 120 nm.

2. The optical reflective member of claim 1, wherein
a mix proportion of lanthanum oxide in the adhesion layer is in a range from 60% to 80% by weight.

3. The optical reflective member of claim 1, wherein
the protective layer has part thereof formed of low-refractive-index layers and high-refractive-index layers laid alternately on one another, an outermost layer of the protective layer being a high-refractive-index layer.

4. The optical reflective member of claim 3, wherein
the high-refractive-index layers are formed of a mixture of titanium oxide and dysprosium oxide, and
the low-refractive-index layers are formed of at least one of the following materials: silicon oxide, aluminum oxide, and a mixture of silicon oxide and aluminum oxide.

5. The optical reflective member of claim 3, wherein
the high-refractive-index layers are formed of at least one of the following materials: a mixture of titanium oxide and lanthanum oxide, and a mixture of a titanium oxide and a tantalum oxide, and
the low-refractive-index layers are formed of at least one of the following materials: silicon oxide, aluminum oxide, and a mixture of silicon oxide and aluminum oxide.

6. The optical reflective member of claim 1, wherein
the protective layer has part thereof formed of low-refractive-index layers and high-refractive-index layers laid alternately on one another, an outermost layer of the protective layer being a low-refractive-index layer formed of silicon oxide or a mixture of silicon oxide and aluminum oxide.

7. A projection apparatus comprising:
a display panel having a display panel surface on which a two-dimensional image is displayed; and
a projection optical system for projecting, while enlarging, the two-dimensional image formed on the display panel surface,
the projection optical system comprising:
an optical reflective member having formed on a surface of a plastic base, from a base side:
an adhesion layer;
a reflective layer formed mainly of Ag; and
a protective layer formed of a light-transmitting dielectric layer,
wherein
the plastic base is formed of cycloolefin resin, and
the adhesion layer is formed of a layer of a mixture of aluminum oxide and lanthanum oxide and has a thickness in a range from 10 nm to 120 nm.

8. The projection apparatus of claim 7, wherein
a mix proportion of lanthanum oxide in the adhesion layer is in a range from 60% to 80% by weight.

9. The projection apparatus of claim 7, wherein
the protective layer has part thereof formed of low-refractive-index layers and high-refractive-index layers laid alternately on one another, an outermost layer of the protective layer being a high-refractive-index layer.

10. The projection apparatus of claim 9, wherein
the high-refractive-index layers are formed of a mixture of titanium oxide and dysprosium oxide, and
the low-refractive-index layers are formed of at least one of the following materials: silicon oxide, aluminum oxide, and a mixture of silicon oxide and aluminum oxide.

11. The projection apparatus of claim 9, wherein
the high-refractive-index layers are formed of at least one of the following materials: a mixture of titanium oxide and lanthanum oxide, and a mixture of a titanium oxide and a tantalum oxide, and
the low-refractive-index layers are formed of at least one of the following materials: silicon oxide, aluminum oxide, and a mixture of silicon oxide and aluminum oxide.

12. The projection apparatus of claim 9, wherein
the protective layer has part thereof formed of low-refractive-index layers and high-refractive-index layers laid alternately on one another, an outermost layer of the protective layer being a low-refractive-index layer formed of silicon oxide or a mixture of silicon oxide and aluminum oxide.

13. An image-sensing apparatus comprising:
an optical reflective member having formed on a surface of a plastic base, from a base side:
an adhesion layer;
a reflective layer formed mainly of Ag; and
a protective layer formed of a light-transmitting dielectric layer,
wherein
the plastic base is formed of cycloolefin resin, and
the adhesion layer is formed of a layer of a mixture of aluminum oxide and lanthanum oxide and has a thickness in a range from 10 nm to 120 nm.

14. The image-sensing apparatus of claim 13, wherein
a mix proportion of lanthanum oxide in the adhesion layer is in a range from 60% to 80% by weight.

15. The image-sensing apparatus of claim 13, wherein
the protective layer has part thereof formed of low-refractive-index layers and high-refractive-index layers laid alternately on one another, an outermost layer of the protective layer being a high-refractive-index layer.

16. The image-sensing apparatus of claim 15, wherein
the high-refractive-index layers are formed of a mixture of titanium oxide and dysprosium oxide, and
the low-refractive-index layers are formed of at least one of the following materials: silicon oxide, aluminum oxide, and a mixture of silicon oxide and aluminum oxide.

17. The image-sensing apparatus of claim 15, wherein
the high-refractive-index layers are formed of at least one of the following materials: a mixture of titanium oxide and lanthanum oxide, and a mixture of a titanium oxide and a tantalum oxide, and
the low-refractive-index layers are formed of at least one of the following materials: silicon oxide, aluminum oxide, and a mixture of silicon oxide and aluminum oxide.

18. The image-sensing apparatus of claim 13, wherein
the protective layer has part thereof formed of low-refractive-index layers and high-refractive-index layers laid alternately on one another, an outermost layer of the protective layer being a low-refractive-index layer formed of silicon oxide or a mixture of silicon oxide and aluminum oxide.
